(19) United States
(12) Patent Application Publication
(10) Pub. No.: US 2006/0226056 A1
(43) Pub. Date: Oct. 12, 2006

(54) Tubeless Ejector Manifold for Use with Sorter

(75) Inventors: Klaus Michael Oestreich, Stafford, TX (US); Lawrence Sheung-Wei Tam, Stafford, TX (US)

Correspondence Address: CRAIN, CATON & JAMES, FIVE HOUSTON CENTER, 1401 MCKINNEY, 17TH FLOOR, HOUSTON, TX, 77010, US

(73) Assignee: Satake USA, Inc., Stafford, TX (US)

(21) Appl. No.: 11/278,777

(22) Filed: Apr. 5, 2006

Related U.S. Application Data
(60) Provisional application No. 60/669,549, filed on Apr. 8, 2005.

(51) Int. Cl. B04C 5/14

(52) U.S. Cl. 209/720

(57) ABSTRACT

An ejector manifold is disclosed for use in sorting of relatively small, granular particles by means of a transverse array of nozzles that selectively direct respective packets of ejecting substance, which may be gas or fluid, toward selected particles to deflect them from their normal direction of travel. The ejecting substance is communicated by means of formed in place piping. Additionally, the ejector manifold may incorporate an internal ejecting substance reservoir. In addition to sorting, the ejector manifold may be used to apply chemicals, paints or other materials to passing particles.

### CROSS REFERENCE TO RELATED APPLICATIONS

This application claims the benefit of U.S. Provisional Patent Application No. 60/669,549 entitled, “Manifold” filed on Apr. 8, 2005 in the United States Patent and Trademark Office.

### STATEMENT REGARDING FEDERALLY SPONSORED RESEARCH OR DEVELOPMENT

Not Applicable.

### FIELD OF THE INVENTION

The present invention relates to manifolds particularly suited for use as ejectors in sorters of transversely-spaced particles moving along a direction of travel, which sorters separate transversely spaced particles according to differences in their characteristics. In particular, the invention relates to an ejector manifold for sorting of relatively small, granular particles by means of a transverse array of nozzles which selectively direct respective packets of ejecting substance, which may be gas or fluid, toward selected particles to deflect them from their normal direction of travel where the ejecting substance is communicated by means of formed-in-place piping and where the ejector manifold may incorporate an internal ejecting substance reservoir. Alternatively such ejector manifold may be used to apply chemicals, paints or other materials to passing particles.

### BACKGROUND OF THE INVENTION

A typical sorting machine of the type envisioned for application of the present invention is a high-speed sorting machine used for sorting small particles, including fungible particles in the food and pharmaceutical industries. However the invention may also be used in conveyor sorting machines or for application of chemicals, paints or other flowing materials.

For example, individual rice grains may be sorted in a gravity-fed sorter to separate grains selected as “substandard.” In the art, “substandard” may apply to a grain having any undesirable characteristic, including color, shape, size or breakage, or any other characteristic not within the limits for acceptable particles for a particular sorting.

Such sorting machines typically employ one or more optical sensors to differentiate based on color hues, although sorting by size, moisture content and other characteristics are known.

Such sorting machines also include one or more ejector mechanisms located downstream of the sensor or sensors with multiple nozzles associated with one or more valves actuated by an electrical signal coordinated with sensor detection. When a particle having or lacking selected criteria is detected, an electrical signal is produced to actuate the valve of the ejector nozzle associated with the predicted location of the selected particle as the selected particle passes the ejector. The time elapsed between the selected particle passing the sensor or sensors and the selected particle being ejected is minimal to limit possible vertical and/or horizontal deflection of the selected particle upon contact with non-selected particles. Each ejector is therefore normally located as close as possible to the plane at which the optical sensor or sensors reviews the passing particles, typically referred to as the scan line, ideally being just downstream therefrom and closely adjacent thereto.

In the prior art, an ejector mechanism may be mechanical, but for small particles it is almost universally a compressed air ejector. When the selected particle arrives opposite the ejector, a sharp expulsion or jet of ejecting substance is emitted through the appropriate nozzle of the ejector to impel the selected particle from the particle stream

The sorting of such smaller particles, particularly at increasingly higher rates of production, introduces difficult requirements with respect to the design of nozzle separation systems. Small particles, closely spaced transverse to their direction of travel, require a corresponding closely-spaced transverse array of small nozzles to emit the sharp expulsion or jet blast of air. Also, the selection of the corresponding nozzle and the timing of activation, both initiation and duration of the blast, must be increasingly accurately controlled as the particle becomes smaller and/or its speed of travel is increased to meet higher production demands. These combined requirements of close transverse nozzle spacing. i.e. ejection nozzle density, and increasingly quicker and more accurate nozzle response have tended to be limited by the capabilities of the currently-known air nozzle separation systems.

Increasing, ejection nozzle density on the face of the ejector creates a myriad of difficulties in operation. The valves, which conventionally are used to control the supply of air to the respective nozzles and are typically solenoid driven, are significantly larger than the nozzles which they control. As a result such valves require lateral space greater than the cumulative lateral distance associated with the nozzles and surrounding support controlled by the valve. As a greater number of nozzles is desired in a uniform length, locating such nozzles within such lateral distance becomes more difficult due to the need for a corresponding number of valves and associated tubing, to communicate with each nozzle. This is in part because the particular valve must be in close proximity to the associated nozzle or nozzles to minimize the delay between the time the valve actuates to permit pressured air or other ejecting substance, to enter the passage associated with the particular nozzle and the time of emission of the ejecting substance from the nozzle. Also, the respective passage lengths between each valve and the nozzles must be substantially equal so that the time between any valve activation and its associated nozzle emissions are uniform for accuracy in deflecting particles. In addition, for purposes of accuracy the nozzles should be located as close to both the particle inspection point and to the path of travel of the particles themselves. These combined requirements are difficult to satisfy in a compatible fashion because of space limitations.

Attempts to increase the number of nozzles generally focus on the limitations of the ejector manifold, which provides communication from the valves to the nozzles. One attempt focused on a linear transverse alignment of air nozzles on the front of a transversely-extending ejector manifold assembly, with large individual valves being arranged in transverse rows peripherally around the top, rear and bottom of the ejector manifold, protruding radially therefrom. However such ejector manifold and valve assembly formed a voluminous structure difficult to position in close proximity to the optical inspection station of the sorter. Additionally the large mass of each valve limited the speed of valve actuation.

A second attempt to increase the number of nozzles, disclosed in U.S. Pat. No. 5,339,965 issued to Klukis et al, focused on the creation of a non-linear array for placement of the valves. Klukis disclosed the placement of all valves in a common plane equidistant from a central point, with flexible tubing flowing from each connection on each valve to a particular nozzle, wherein each tubing was measured to be equal length, then bound to the other tubings and encased within a mass of hardened polymeric material. However, various problems with the use of such an array became apparent. Tubing connections to the nozzles and to the valves were susceptible to human error, including overtightening of connections. Tubing lengths were not uniform, whether as a result of short connections or connections not entirely aligned with the output from the valve. Twisting of the flexible tubing from the valve to the nozzle could result in deformation of the tubing, reducing the cross sectional area and thereby altering the flowrate of the air to the nozzle. Finally, to obtain equal tubing lengths required locating the nozzles at a distance from the valves, increasing the size of the ejector manifold and creating difficulties in machine design.

### SUMMARY OF THE INVENTION

The present invention overcomes the foregoing drawbacks of previous nozzle separation systems.

In one aspect of the present invention, each nozzle of a transversely-aligned, mutually adjacent groups of nozzles communicates through a ejector manifold with mutually adjacent supply valves which may be arranged in a linear array on a common plane extending generally in the direction of alignment of the group of nozzles. Additionally, the nozzles may also be arranged in multiple rows. The ejector manifold, rather than being a composite of flexible tubing and other materials, is produced by successively-creating multiple adhered layers, thereby producing internal piping of uniform cross sectional area and length, in arrangements not possible by use of pre-existing flexible tubing or current molding technology.

In another embodiment of the invention, the nozzles are also produced by successively creating multiple adhered layers.

In another embodiment of the invention, an accumulator which supplies ejecting substance to the values for each nozzle is incorporated into the body of the ejector manifold.

In another embodiment of the invention in which the accumulator is incorporated into the body of the ejector manifold, the ejector manifold is constructed to permit joining of two or more ejector manifolds to create an ejector manifold having a greater number of nozzles.

In another embodiment of the invention, a fluid, rather than a gas, is used for ejection.

The use of three-dimension production to create the ejector manifold, namely the successive layering of multiple layers, enables the use of extremely compact conventional valve groups of low mass and extremely quick response in such a way as to achieve short and substantially uniform delay times between valve actuation and nozzle emission. Alternatively, such three-dimensional production permits use of an accumulator or reservoir internal to the ejector manifold that may communicate with one or more external or internal valves for activation of the ejector nozzles. The use of piping created by production of multiple layers to connect a valve with its respective nozzles additionally enables the construction of a highly compact nozzle system having short and uniform delay times.

The foregoing and other objectives, features, and advantages of the invention will be more readily understood upon consideration of the following detailed description of the invention, taken in conjunction with the accompanying drawings.

### BRIEF DESCRIPTION OF THE DRAWINGS

So that the manner in which the described features, advantages and objects of the invention, as well as others which will become apparent, are attained and can be understood in detail, more particular description of the invention briefly summarized above may be had by reference to the embodiments thereof that are illustrated in the drawings, which drawings form a part of this specification. It is to be noted, however, that the appended drawings illustrate only typical preferred embodiments of the invention and are therefore not to be considered limiting of its scope as the invention may admit to other equally effective embodiments.

In the drawings:

FIG. 1 is a front view of a sorter of the type with which the ejector manifold may be used.

FIG. 2 is a side view of a sorter of the type with which the ejector manifold may be used.

FIG. 3 is an isometric view of a simplified laser sintering technique for manufacturing the ejector manifold.

FIG. 4 is an isometric view of a simplified stereolithography technique for manufacturing the ejector manifold.

FIG. 5 is an isometric view of the first embodiment of the ejector manifold, characterized by a single valve plane showing the interior passages.

FIG. 6 is an isometric view of the second embodiment of the ejector manifold, characterized by multiple valve planes showing the internal passages.

FIG. 7 is an isometric view of exterior of the second embodiment of the ejector manifold, characterized by multiple valve planes.

FIG. 8 is an exploded isometric view of the ejector manifold with external valves.

FIG. 9 is an isometric view of the alternative embodiment having an internal accumulator.

FIG. 10 is a second isometric view of the alternative embodiment having an internal accumulator.

FIG. 11 is an end view of the alternative embodiment having an internal accumulator or reservoir.

FIG. 12 is an exploded isometric view of the alternative embodiment having an internal accumulator or reservoir.

FIG. 13 is an isometric view of an alternative embodiment having two valves per passage.

FIG. 14 is an isometric view of an alternative embodiment having two passages per valve.

FIG. 15 is an isometric view of an alternative embodiment having an external, detachable accumulator.

### DETAILED DESCRIPTION OF THE PREFERRED EMBODIMENT

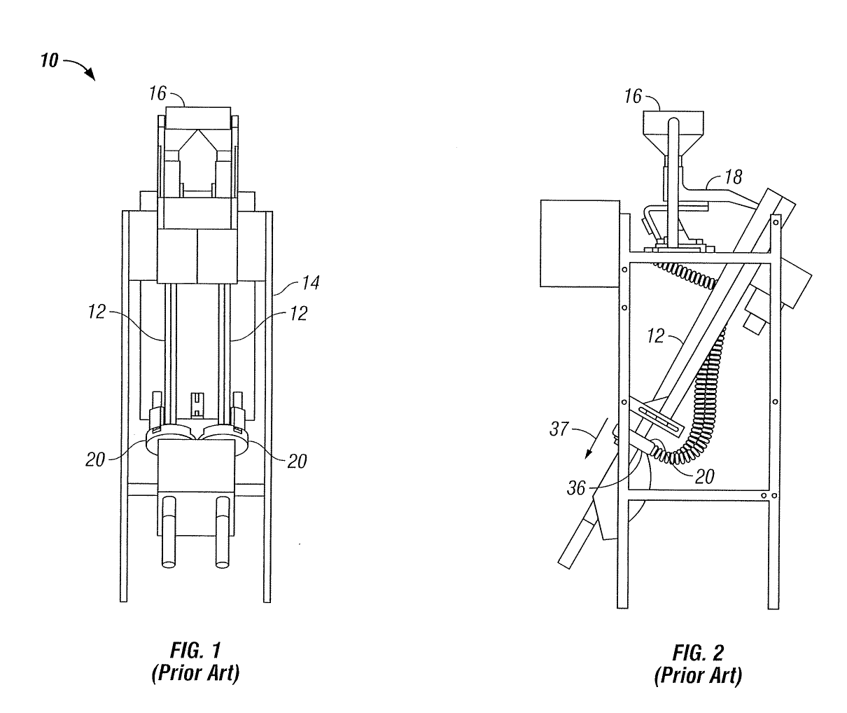

Referring to the FIGS. 1 and 2, a multi-channel, high-speed sorter for separating nonstandard particles from a passing stream or flow of such particles is shown. Generally, a typical sorting machine 10 includes one or more chutes or slides 12 at a steep angle, usually over 45 degrees from the horizon and preferably nearly vertical on the order of 80 degrees. The chutes are held in position by a framework 14. A hopper 16 containing particles to be sorted is attached to the same framework and provides gravity feed of the particles by respective feeder tray 18 to chutes 12. Particles to be separated or sorted is any small particle or particles, such as rice grains. Particle flow rate is less than free fall due to friction between particle and channel surface. As a result particle flow rate is quite high, as is well-known in the art. Machines having only a single channel and machines with many more than two channels are not uncommon. For separation or sorting machine 10 contains at least one sensor, which may be an optical sensor 20, to scan passing particles. The plane at which optical sensor 20 reviews the passing particles is typically referred to as the scan line. When a particle to be separated from the passing flow is identified from the output of an optical sensor 20, the corresponding nozzle of ejector 36 is engaged, deflecting the selected particle from particle direction of travel 37.

Moreover the present invention may be used with any system whereby particles are moved along a chute or belt.

Unlike the prior art, ejector manifold 50 is not formed about tubing or by a mold. Rather ejector manifold 50 is formed by three-dimensional production, which may be by stereolithography, laser sintering, or other similar manufacturing methods using lamination of single or near-singular material thickness layers which may use, among other materials, photosensitive resins. Three dimensional production permits creation of ejector manifold 50, including the passages 507, each providing communication between a nozzle 501 and its respective port connector 506, without the need for tubing. In prior art, which required installation of tubing, shortening, lengthening, or internal alteration of the tubing due to human error could alter the speed, direction or duration of flow therethrough.

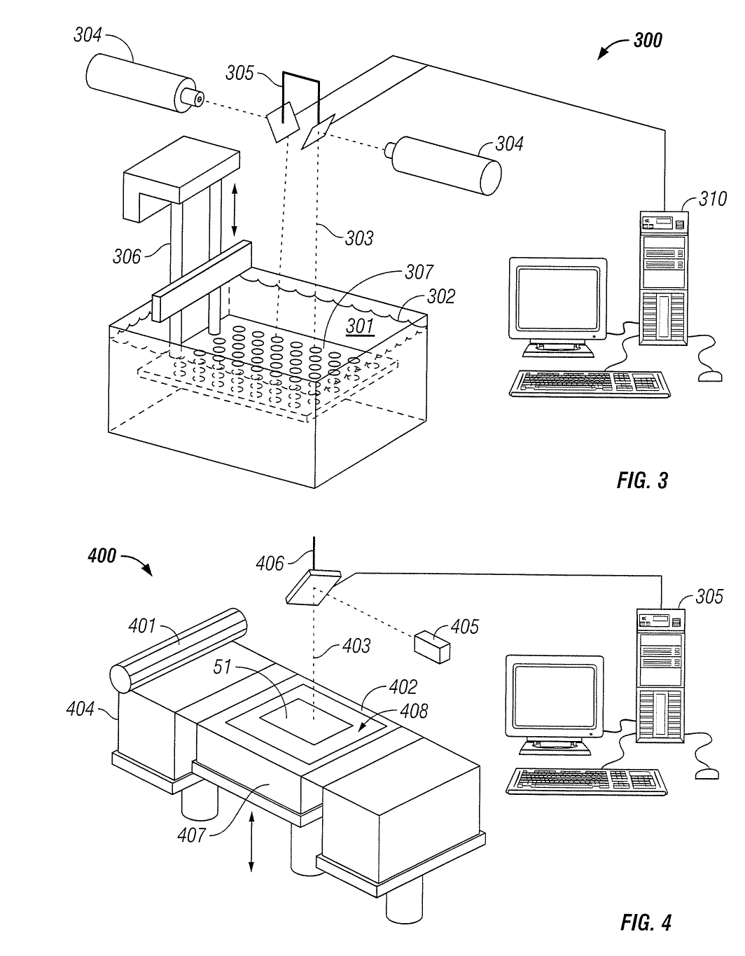

As depicted in FIG. 3, one method known in the art for production of a three-dimensional object is stereolithography, 300. However this method of production has not been applied to production of an ejector manifold. In stereolithography, the working surface 307 of a moveable table or elevator 306 initially is placed at a position below surface 301 of liquid photopolymer resin 302. Typically the light source is one or more lasers 304. Light 303 is directed from laser 304 by redirection system 305, controlled by computer 310, to the surface of liquid photopolymer resin 302 to map the geometry of successive cross section layers of ejector manifold 50. Redirection system 305 may be a set of computer-driven actuators connected to mirrors or any other system known in the art. Liquid photopolymer 302 solidifies where light 303 is applied, forming a cross sectional layer. After a cross sectional layer of ejector manifold 50 is completely formed, table 306 is lowered no more than one post-solidification material thickness of liquid photopolymer resin 302, i.e. one layer, and the process repeated atop the prior cross section layer of ejector manifold 50.

As depicted in FIG. 4. an alternative method for producing ejector manifold by adhering successive cross sections is laser sintering. In laser sintering, the working surface 408 of a moveable table or elevator 407 initially is placed at a vertical position nearly equal power feed roller 401 in build envelope 402. Powder feed roller 401 receives powder from powder feed cartridge 404. Powder is evenly spread across build envelope 402. An intense light source, typically a laser 405, maps each layer of ejector manifold 50 on the powder, which locally melts the powder and fuses the melted powder to adjacent powder. Light from laser 405 is directed by redirection system 406 controlled by computer 410 to working surface 408 to map the geometry of successive cross section layers of ejector manifold 50. Redirection system 406 may be a set of computer-driven actuators connected to mirrors or any other system known in the art. Build envelope 402 is then lowered one powder thickness by a moveable table 407 and the process repeated.

In both methods, a photosensitive resin is used for construction of the various layers. Any method known in the art for three-dimensional manufacturing or production via creation of successive adhered cross sections may be used. Additionally, while such resin bonds to each adjacent layer during such solidification in the preferred embodiment, layers may be bonded after formation by application of heat or adhesive between such layers.

Tubeless ejector manifold 50 therefore exists first within a computer-aided drafting (CAD) program resident on a computer 310 or 410, which permits successive layers of one material thickness to be created. Such layers of ejector manifold 50 may therefore be exported to the three-dimensional manufacturing system for fabrication.

When complete by such three-dimensional manufacturing, ejector manifold 50 has passages in locations, dimensions, and in passage density more precise than conventional tubing or molds. Moreover such passages may be smaller than those constructed with conventional tubing.

Such production also permits variation in the number of faces for mounting of valves 505 to communicate with ejector manifold 50.

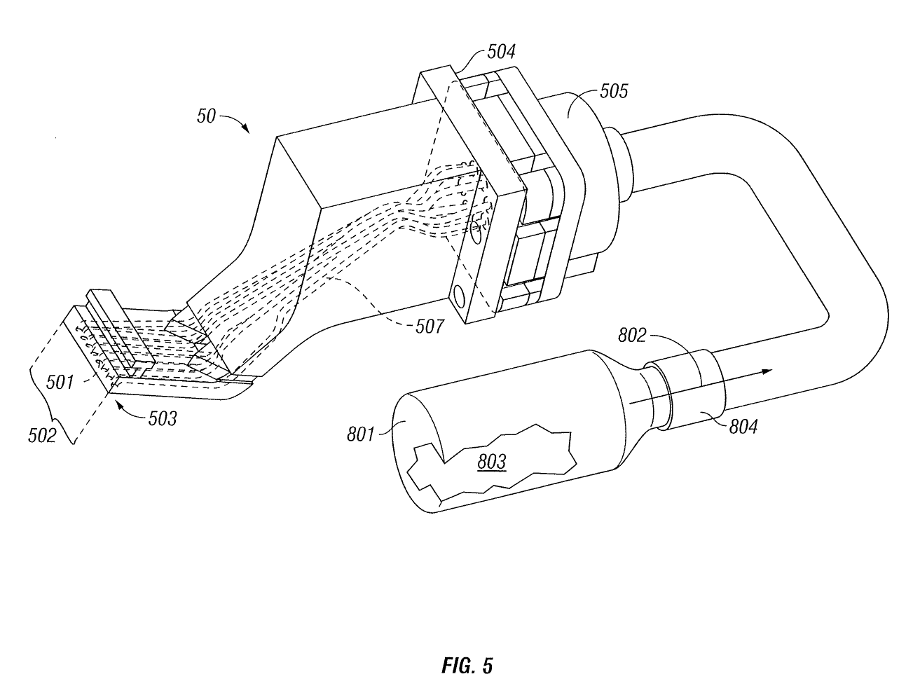

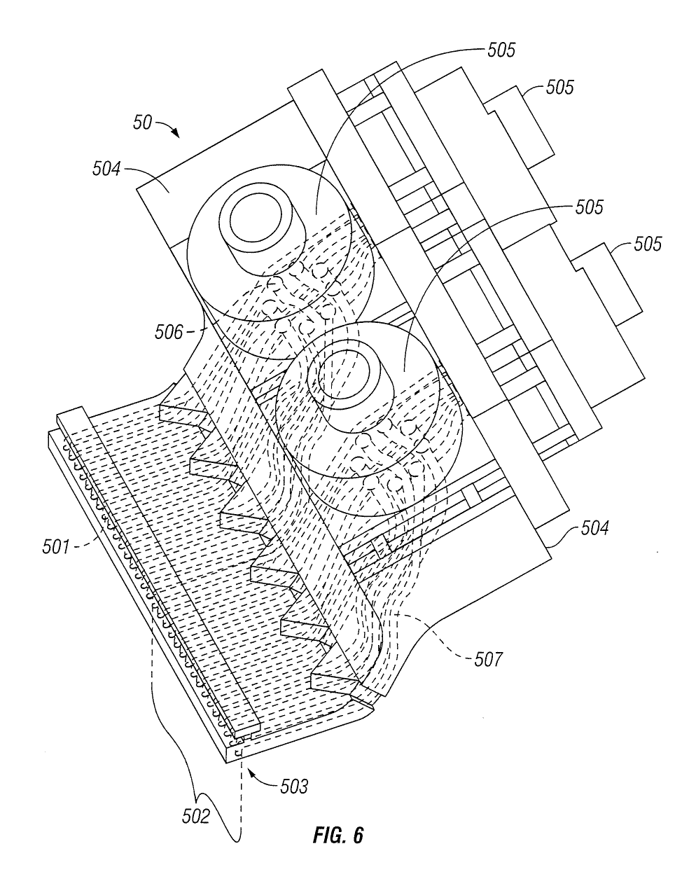

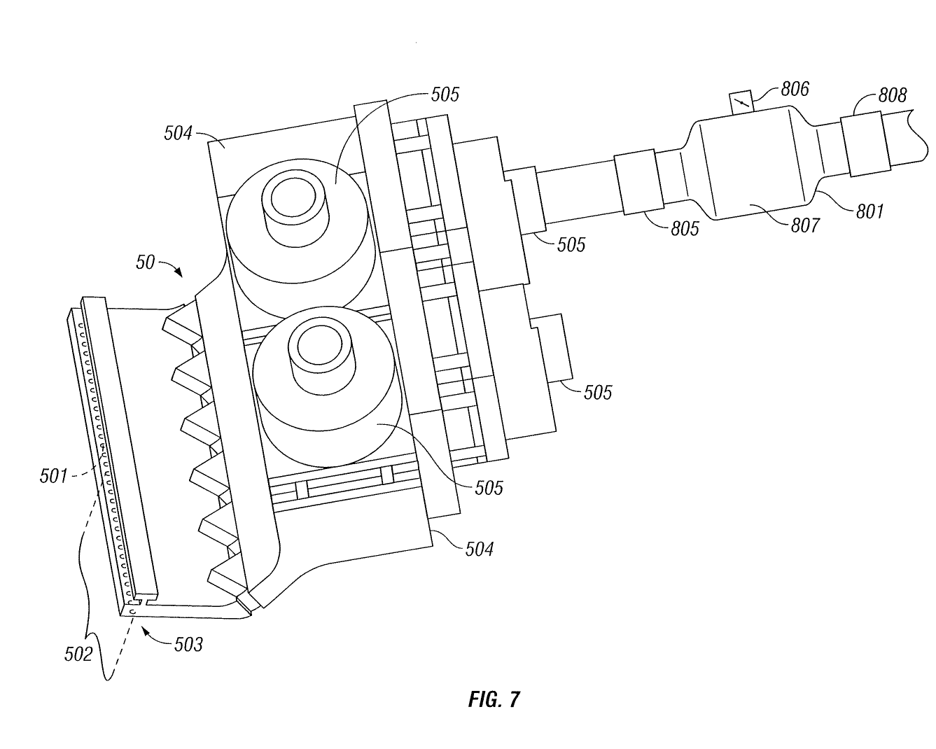

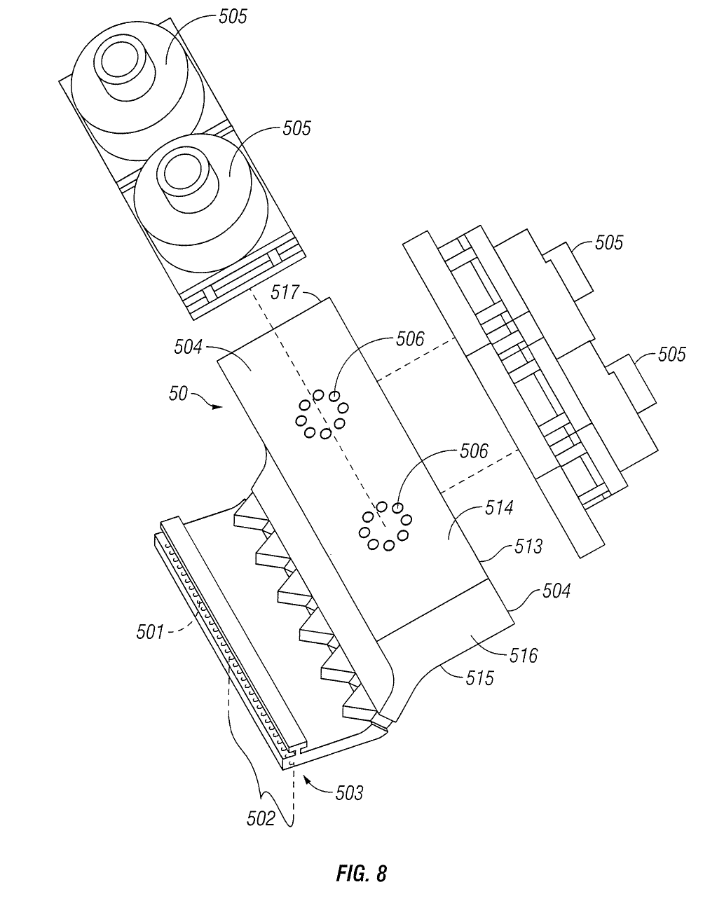

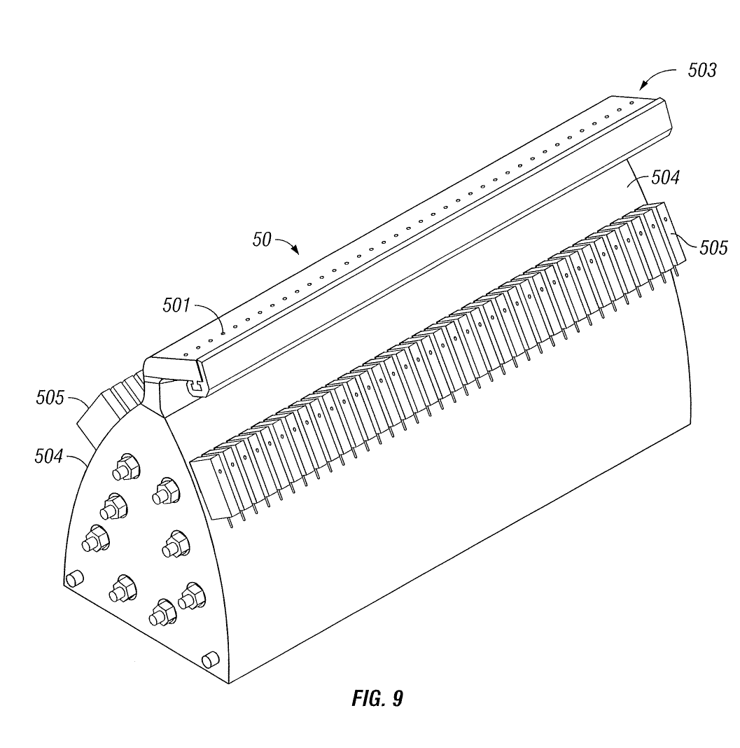

With reference to FIGS. 5-8, the preferred embodiment of ejector manifold 50 has a plurality of nozzles 501, which are arranged into mutually adjacent groups 502 on row 503, each group being in a linear transverse alignment relative to the direction of travel 37, as shown in FIG. 2, of the particles. In the preferred embodiment a single row of nozzles is provided. However multiple rows of nozzles may alternatively be provided.

Ejector manifold 50 has at least one plane 504 for providing communication with valves 505. The geometry of ejector manifold 50 may be constructed to permit multiple planes 504 for valves 505. Each valve 505 communicates to at least one port connector 506, connected to a respective passage 507, which is in turn connected to a unique nozzle 501. In the preferred embodiment each valve 505 communicates with eight (8) or nine (9) port connectors 506, arranged in a circular pattern. However any number of ports is permissible as is the orientation of port connectors 506 in relation to the valve 505. Moreover in an alternative embodiment, depicted in FIG. 13, more than one valve 505 may communicate to a passage 507, such that the time necessary for a single valve 505 to cycle through activation, deactivation, and reactivation may be avoided by sequential activation of one or more subsequent valves 505 to introduce ejecting substance from ejecting substance source 801 into a single passage 507. The connection of passages from two valves to a passage for a single nozzle is made possible by the three-dimensional manufacturing technique, which permits the precise location of a Y-connector without the alteration in cross-sectional area typical where such joints intersect piping.

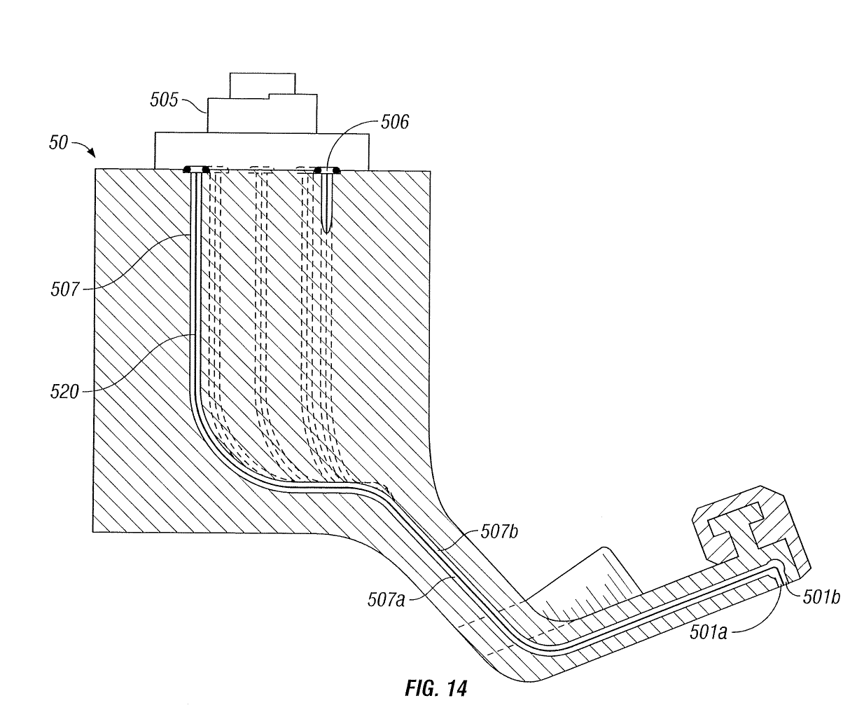

In a further alternative embodiment, shown in FIG. 14, a plurality of passages 507, namely passages 507a and 507b, may be connected to a single port connector 506. It is thereby possible to divide the ejecting substance 803 released by a valve 505 among a plurality of nozzles 501, namely nozzles 501a and 501b, which may be connected to passages smaller than those conventionally possible with tubing. The increase in nozzle number for the same area may be beneficial to prevent the blocking of any nozzle by dust or passing particles and for more precise ejection.

As depicted in FIG. 5, each valve 505 is connected to an ejecting substance source 801, which may be one or more sources of ejecting substance 803. In the preferred embodiment, the ejecting substance 803 associated with ejecting substance source 801 is air, although other ejecting substances 803 may be used dependent on the characteristics of the particles to be separated, potential or intended modification of the passing particle, and governmental regulations. In the preferred embodiment ejecting substance source 801 is a pressurized container, which may be connected to a pressure regulator 804 on its outflow 802. Alternatively as shown in FIG. 7 ejecting substance source 801 may be an accumulator 807 having a directional valve 805 and a pressure relief valve 806 connected to an impeller 808 so as to maintain a constant pressure in ejecting substance source 801 during operation. Ejecting substance 803 is supplied to valves 505 from ejecting substance source 801. When activated, a valve 505 permits ejector substance 803 to flow to a port connector 506, permitting ejector substance 804 to pass through a respective passage 507 and ultimately to a respective nozzle 501. Valve 505 deactivates when sufficient volume of ejecting substance 803 has passed through valve 505 to deflect the intended particle at nozzles 501.

In the preferred embodiment, for use with small particles, as depicted in FIG. 7, nozzles 501 are located at the end of protrusion 508, which extends from the body 509 of ejector manifold 50. Protrusion 508 sufficiently extends from a first side 512 of body 509 of ejector manifold to locate nozzles 501 proximate optical sensor 20 so as to minimize the distance and particle-travel time between the scanline of one or more optical sensors 20 and nozzles 501. Minimization of distance, and correspondingly of time, reduces the possibility that selected particle may interact with adjacent particles or travel diagonally and thus the possibility that selected particle will not be properly ejected at the corresponding nozzle 501 of ejector 36.

In the preferred embodiment protrusion 508 includes a number of tunnels 510 penetrating through body 509 and sized to allow misguided particles which might otherwise be retained atop protrusion 508 to pass through protrusion 508 of ejector manifold 50 and not amass atop ejector manifold 10. To aid in direction of misguided particles through tunnel 510, tunnel 510 is bounded by angled sides 511, the intersection of two angled sides 511 forming a wedge or funnel to direct the misguided particles to tunnel 510. Should ejector manifold 50 be used in connection with relative large particles, particularly particles of such a size that the time for each particle to pass entirely before scan line of optical sensor 20 is relatively long high nozzle density and therefore protrusion 508, is unnecessary.

As a result of three-dimensional production, the ejector manifold 50 includes a body 509. Body 509 of ejector manifold 50 is constructed to have at least a first 512 and second side 513, a top 514 and bottom side 515, and a first 516 and second end 517. Ejector manifold 50 contains a nozzle 501 located proximate the first side 512 of the body of ejector manifold 50. While nozzle 501 may be composed of any material, in the preferred embodiment nozzle 501 is formed in the same manner as body 509 so as to avoid the need for the excessive machining associated with internal passages 507. In the preferred embodiment, the layers of nozzle 501 are co-planar to layers of body 509 and formed concurrently and at least one layer of nozzle 501 and one layer of body 509 are formed integrally. Ejector manifold 50 also includes at least one valve port connector 506 formed at the second side 513 of said body. The valve port connector 506 is formed in the same manner as body 509 so as to avoid the need for the excessive machining associated with internal passages 507. The layers of valve port connector 506 co-planar to layers of body 509 are formed concurrently and at least one layer of nozzle 501 and one layer of body 509 are formed integrally. Body 509 is formed to include by absence of photosensitive resin at least one passage 507 communicating with at least one of nozzle 501 and with at least one passage 507 communicating with at least one of said valve port connectors 506. Each nozzle 501 communicates with only one passage 507 and only one valve port connector 509. However in alternative embodiments it may be desirable to include multiple valves for a passage to permit more rapid cycling of nozzle operation and/or to include multiple nozzles for a valve to increase the effective nozzle size by simultaneous activation of numerous nozzles by a single valve. Moreover, in alternative embodiments such fluid may be a chemical or food application, gas, or small solid particles that flow fluidically.

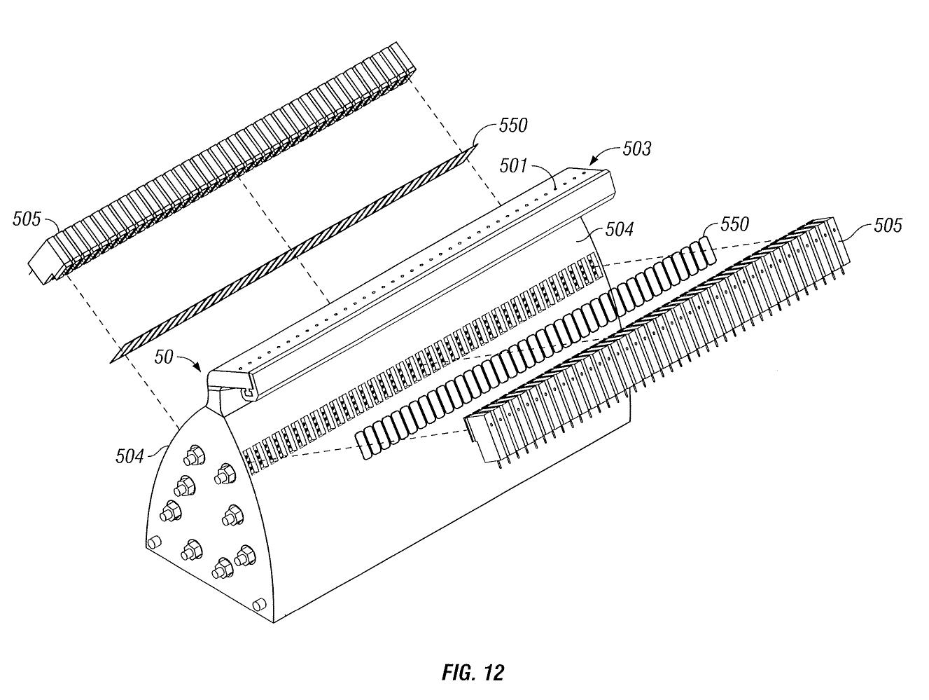

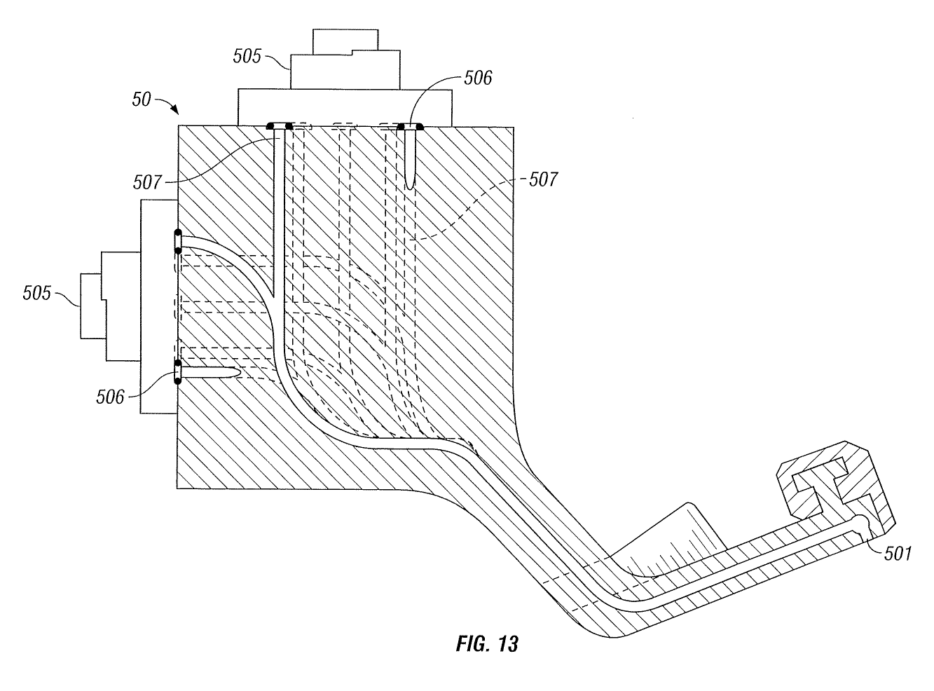

In a first alternative embodiment, depicted in FIGS. 9-13, ejector manifold 50 is produced with an internal accumulator or reservoir 901. Internal accumulator or reservoir 901 may be maintained at a predetermined pressure by any manner of options known in the art, including a combination of directional valves and pressure-relief valves or by connection to a pressure source which maintains constant outflow pressure. In the first alternative embodiment, the internal accumulator or reservoir 901 is formed by creation of a void within the body of the ejector manifold 50 during the production process. In the preferred embodiment internal accumulator or reservoir 901 is cylindrical to equalize forces about the interior of internal accumulator or reservoir 901 and to minimize stress concentrations. However alternative shapes may be used. Additionally, internal accumulator or reservoir 901 may be formed by use of a pre-existing canister 902. In such an event ejector manifold 50 is formed by locating pre-existing canister 902 in moveable table or elevator 306 or 407, or equivalent table or elevator when three-dimension production methods other than stereolithography or laser sintering are used, such that when ejector manifold is formed, it is formed about pre-existing canister 902. It is understood in the art that three-dimensional production about a pre-existing object may require the use of ribs or other supports to maintain the pre-existing object in position during production.

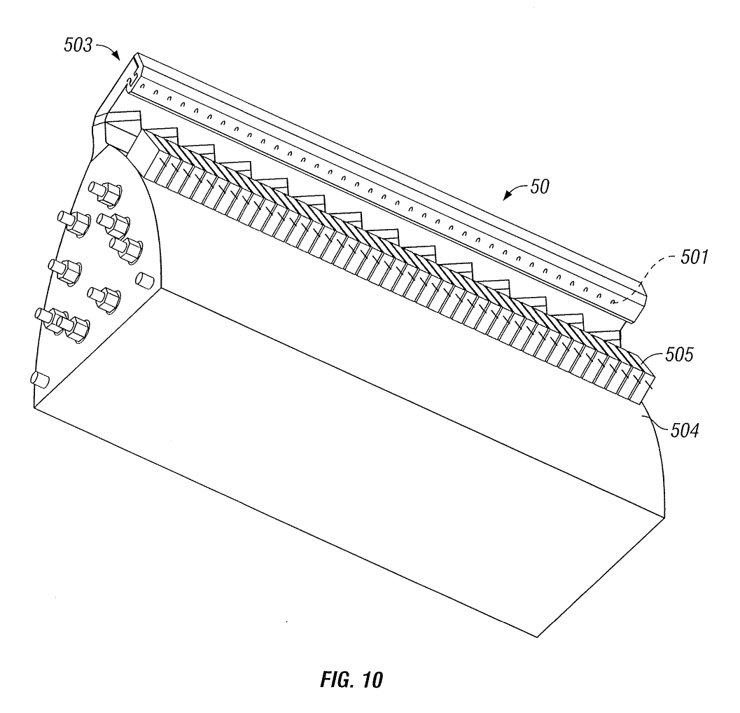

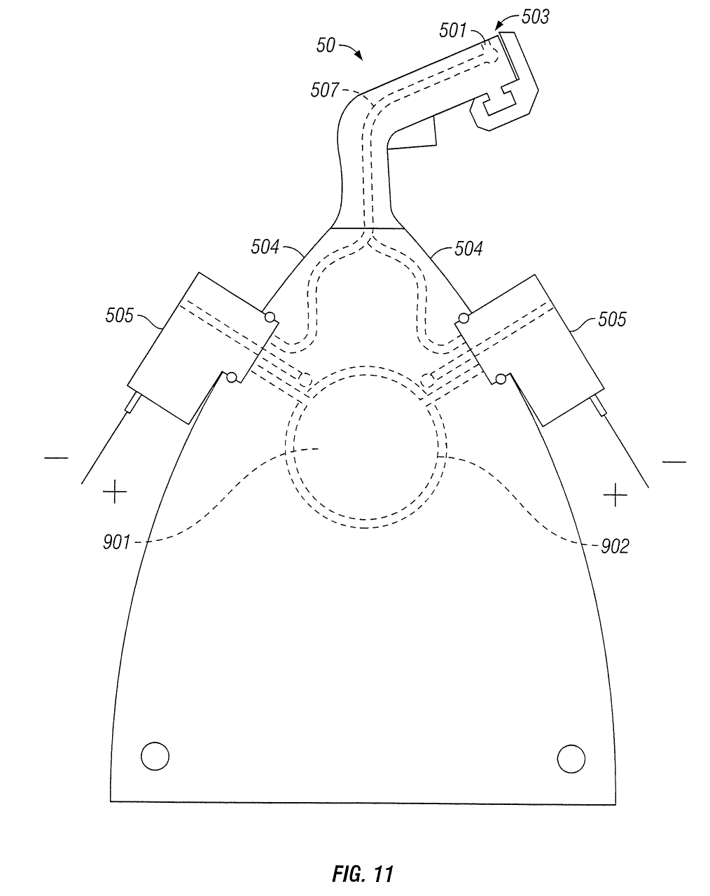

In the first alternative embodiment, internal accumulator or reservoir 901 may be constructed so as to communicate at one or both ends of ejector manifold 50 with an adjacent ejector manifold 50, as shown in FIG. 10. Ejector manifold 50 may be constructed as to permit mating to an adjacent ejector manifold 50 so as form an ejector manifold having more nozzles. By such mating internal accumulator or reservoir 901 may likewise be elongated.

Referring to FIG. 13, in the first alternative embodiment the presence of internal accumulator or reservoir 901 requires that internal passage ways 1301 permit communication between internal accumulator or reservoir 901 and valves 505, located externally. When activated, a valve 505 is directed to permit fluid flow to a port connector 506, forcing fluid through a respective passage 507 and ultimately to a respective nozzle 501. When the volume of ejecting substance 803 has passed through valve 505 for nozzle 501 to deflect the intended particle, valve 505 deactivates. In this first alternative embodiment passageways 507 are routed about internal accumulator or reservoir 901. However, due to the use of three-dimensional production and the ability to avoid creating material junctures or welds, passageways 507 may be constructed so as to pass directly through (not shown) internal accumulator or reservoir 901 when a pre-existing canister 902 is not used. In the first alternative embodiment valve 505 has both inlet and outlet on the same plane. In the first alternative embodiment, valve 505 is a plunger valve wherein valve 505 communicates with a single inflow passage 1301 and a single port connector 506 and a single passageway 507. Such single-passage plunger valves typically also include a vent 1302 that permits valve 505 to vent when not permitting flow to single port connector 506. In the preferred embodiment of the first alternative embodiment, valve 505, port connector 506, and internal passage 1301 are located proximate nozzle 501 but not closer than tunnel 510. Location of valve 505, port connector 506, and internal passage 1301 are located proximate nozzle 501 but not closer than tunnel 510 reduces the volume of fluid required for ejection, reduces the volume of fluid required to be contained within internal accumulator or reservoir 901, and reduces the dimension of ejector manifold 50 normal to the particle direction of flow 37.

In a second alternative embodiment, depicted in FIG. 14, a valve 1405 may be incorporated into ejector manifold 50 proximate each nozzle 501 by location of the valve 1405 and associated wiring at the proper location during production of ejector manifold 50. Location of a valve 1405, which may be a piezoelectric valve, proximate nozzle 501 reduces the volume of ejecting substance 803 between valve 1405 and nozzle 501, preventing contamination or pressure loss of ejecting substance 803 between valve 1405 and nozzle 501 during operation. Depending on the characteristics of ejecting substance 803, ejecting substance 803 may dry between activations, reducing the cross sectional area of the respective passage 507 and altering the frictional coefficient of the surface of the respective passage 507. Either such condition may affect the flow rate of ejecting substance 803 at nozzle 501 during operation, resulting in a degradation of ejection characteristics. Thus location of valve 1405 proximate nozzle 501 reduces or eliminates the possibility of either such condition.

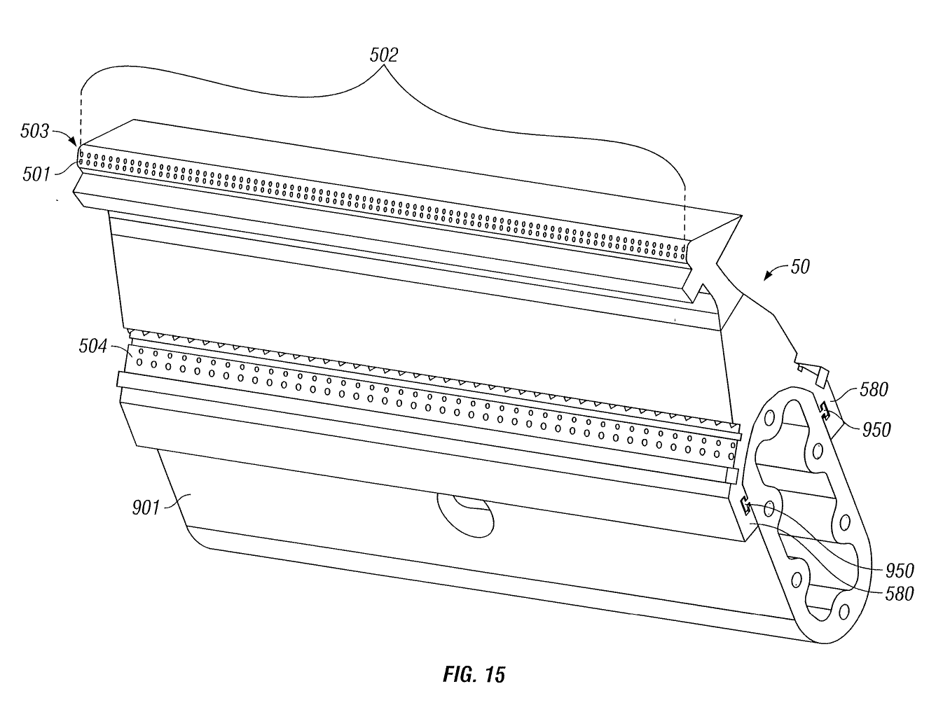

In a further alternative embodiment, FIG. 15, internal accumulator or reservoir 901 may be formed so as to be detachable from body 509 of ejector manifold 50, such that internal accumulator or reservoir 901 may detached from body 509 when exhausted, when a different fluid, fluidic solid, or gas is desired to be used, or when a cleaning fluid is desired to be used. Reservoir 901 is rigidly connected to ejector manifold 50. In the preferred embodiment, reservoir 901 is rigidly connected to ejector manifold 50 by two connectors 950, each of which mates to a receiving connector 580 on ejector manifold 50. Connectors 950 are intended to be slid into receiving connectors 580, through alternative connector, such as slotted and keyed connectors, are well known in the art. The use of replaceable internal accumulator 901 permits elimination of larger pressuring systems in lieu of smaller replaceable canisters and reduces the volume of fluid necessary to be stored proximate ejector manifold 50. Moreover the use of replaceable internal accumulator 901 permits manufacture of replaceable internal accumulator 901. Such detachable internal accumulator or reservoir 901 may also be constructed so as to best contain the particular fluid contained therein, which construction may vary from material to material. As constructed body and replaceable internal accumulator 901 would permit communication between passages in body and mating passages in replaceable internal accumulator 901.

The terms and expressions which have been employed in the foregoing specification are used therein as terms of description and not of limitation, and there is no intention, in the use of such terms and expressions, of excluding equivalents of the features shown and described or portions thereof.

I claim:

1. A particle ejector for use in a machine for separating a particle not conforming to predetermined criteria from a stream of said particles by application of an ejection substance to said particle not conforming to predetermined criteria.
said machine opening a valve when said particle not conforming to predetermined criteria from said stream of said particles is detected,
said valve communicating with an ejection substance under pressure, said particle ejector comprising:
a) a body of successively adhered layers of material;
b) at least one nozzle,
i) said at least one nozzle located on said body,
ii) said at least one nozzle directed to said stream of said particles,
iii) said at least one nozzle constructed by the absence of material in said successively adhered layers of material of said body,
c) at least one passage,
i) said at least one passage communicating with said at least one nozzle,
ii) said at least one passage constructed by the absence of material in said successively adhered layers of material of said body,
iii) said at least one passage located within said body,
d) at least one valve plane on said body,
i) said at least one valve plane constructed by said successively adhered layers of material of said body,
ii) said at least one valve plane constructed to receive said at least one valve,
e) at least one port connector,
i) said at least one port connector communicating with said at least one passage.
ii) said at least one port connector constructed by the absence of material in said successively adhered layers of material of said body,
iii) said at least one port connector being on said at least one valve plane.

2. The particle ejector of claim 1, further comprising
at least one ejector substance reservoir,
i) said at least one ejector substance reservoir communicating with said at least one valve,
ii) said at least one ejector substance reservoir containing said ejection substance under pressure.

3. The particle ejector of claim 2 wherein:
said at least one ejector substance reservoir constructed by the absence of material in said successively adhered layers of material of said body.

4. The particle ejector of claim 3 wherein:
said at least one ejector substance reservoir is cylindrical.

5 The particle ejector of claim 4 wherein:
said at least one ejector substance reservoir has a first end and a second end;
said at least one ejector substance reservoir having at least one male connector at said first end of said one ejector substance reservoir;
said at least one ejector substance reservoir having at least one female connector at said second end of said one ejector substance reservoir.

6. The particle ejector of claim 2 wherein:
said at least one ejector substance reservoir being a container inserted into an internal void in said successively adhered layers of material of said body.

7. The particle ejector of claim 6 wherein:
said at least one ejector substance reservoir is cylindrical.

8 The particle ejector of claim 7 wherein:
said at least one ejector substance reservoir has a first end and a second end;
said at least one ejector substance reservoir having at least one male connector at said first end of said one ejector substance reservoir;
said at least one ejector substance reservoir having at least one female connector at said second end of said one ejector substance reservoir.

9. The particle ejector of claim 2 wherein:
said at least one ejector substance reservoir detachably attached to said body.

10. The particle ejector of claim 1, wherein:
said body having a protrusion.
said protrusion having an end;
said at least one nozzle located proximate said end of said protrusion:
at least one tunnel penetrating through said body.
said at least one tunnel sized to permit a plurality of said particles to pass therethrough,

11. The particle ejector of claim 11, wherein:
said at least one tunnel having a first end and a second end
said first end of said at least one tunnel including a funnel.

12. The particle ejector of claim 11, further comprising
at least one ejector substance reservoir,
i) said at least one ejector substance reservoir communicating with said at least one valve,
ii) said at least one ejector substance reservoir containing said ejection substance under pressure.

13. The particle ejector of claim 12 wherein:
said at least one ejector substance reservoir constructed by the absence of material in said successively adhered layers of material of said body.

14. The particle ejector of claim 13 wherein:
said at least one ejector substance reservoir is cylindrical.

15. The particle ejector of claim 14 wherein:
said at least one ejector substance reservoir has a first end and a second end;
said at least one ejector substance reservoir having at least one male connector at said first end of said one ejector substance reservoir:
said at least one ejector substance reservoir having at least one female connector at said second end of said one ejector substance reservoir;

16. The particle ejector of claim 12 wherein:
said at least one ejector substance reservoir being a container inserted into an internal void in said successively adhered layers of material of said body.

17. The particle ejector of claim 16 wherein:
said at least one ejector substance reservoir is cylindrical.

18. The particle ejector of claim 17 wherein:
said at least one ejector substance reservoir has a first end and a second end;
said at least one ejector substance reservoir having at least one male connector at said first end of said one ejector substance reservoir:
said at least one ejector substance reservoir having at least one female connector at said second end of said one ejector substance reservoir.

19. The particle ejector of claim 11 wherein:
said at least one ejector substance reservoir detachably attached to said body.

20. A particle ejector for use in a machine for separating a particle not conforming to predetermined criteria from a stream of said particles by application of an ejection substance to said particle not conforming to predetermined criteria,
said machine opening a valve when product not conforming to predetermined criteria from said stream of said particles is detected,
said valve communicating with an ejection substance under pressure, said particle ejector comprising:
a) a body of successively adhered layers of material;
b) at least one nozzle,
i) said at least one nozzle located on said body,
ii) said at least one nozzle directed to said stream of said particles,
iii) said at least one nozzle constructed by the absence of material in said successively adhered layers of material of said body,
c) at least one passage,
i) said at least one passage communicating with said at least one nozzle,
ii) said at least one passage constructed by the absence of material in said successively adhered layers of material of said body,
iii) said at least one passage located within said body,
d) an ejector substance reservoir,
i) said ejector substance reservoir being formed of metal;
ii) said ejector substance reservoir having at least one connector thereon;
iii) said at least one connector of said ejector substance reservoir being received by said body at a body receiving connector,
(A) said body receiving connector being formed of successively adhered layers of material
e) at least one port connector,
i) said at least one port connector communicating with said at least one passage,
ii) said at least one port connector constructed by the absence of material in said successively adhered layers of material of said body,
iii) said at least one port connector being on said at least one valve plane;
f) at least one valve plane on said body,
i) said at least one valve plane constructed by said successively adhered layers of material of said body,
ii) said at least one valve plane constructed to receive said at least one valve; and
g) at least one valve, said valve being affixed to said valve plane and communicating therethrough with said ejector substance reservoir and with said at least one port connector.
